(19) United States
(12) Patent Application Publication
(10) Pub. No.: US 2025/0379322 A1
(43) Pub. Date: Dec. 11, 2025

(54) POWER STORAGE DEVICE

(71) Applicant: Prime Planet Energy & Solutions, Inc., Tokyo (JP)

(72) Inventors: Satoshi FUJIMURA, Toki-shi (JP); Yozo UCHIDA, Toyota-shi (JP)

(21) Appl. No.: 19/172,653

(22) Filed: Apr. 8, 2025

(30) Foreign Application Priority Data
Jun. 10, 2024 (JP) 2024-093741

(51) Int. Cl. H01M 50/342; H01M 50/186; H01M 50/191

(52) U.S. Cl. CPC H01M 50/3425; H01M 50/186; H01M 50/191

(57) ABSTRACT

A power storage device includes a metal case with a safety valve part. The safety valve part includes a hole surrounding edge portion that forms a valve hole penetrating through the case and a valve member hermetically sealing this valve hole. The valve member includes a plate circumferential edge portion and a ring-shaped resin valve member that is made of thermoplastic resin and hermetically seals a space between the plate circumferential edge portion of the metal seal plate and the hole surrounding edge portion of the case. The safety valve part is a first safety valve part of a temperature opening type to be opened by softening or melting of the resin valve member by heat.

### CROSS-REFERENCE TO RELATED APPLICATIONS

This application is based upon and claims the benefit of priority to Japanese Patent Application No. 2024-093741 filed on Jun. 10, 2024, the entire contents of which are incorporated herein by reference.

### BACKGROUND

### Technical Field

The disclosure relates to a power storage device provided with a metal case including a safety valve part.

### Related Art

Secondary batteries with electrode bodies housed in metal cases, such as a lithium-ion secondary battery, which will be also hereafter simply referred to as a “battery”, are each provided with a safety valve in the case. This is to release gas out of the case to reduce the internal pressure of the case in the event that the battery is crushed by an accident, for example, and the housed electrode body internally short-circuits, generating abnormal heat and generating gas in the case.

One example of the battery provided with such a safety valve that opens when the internal pressure exceeds the operation pressure (herein, also referred to as a pressure opening type) is disclosed in Japanese unexamined patent application publication No. 2017-117750 (JP2017-117750A). The battery in this publication includes an electrode body housed in a rectangular parallelepiped box-shaped case made of metal. This case is composed of a bottomed rectangular tube-shaped case body and a rectangular narrow plate-like shaped lid that seals a rectangular opening portion of the case body. The safety valve is provided in this lid.

Further, Japanese unexamined patent application publication No. 2017-004917 (JP2017-004917A) discloses a battery provided with a pressure opening type safety valve. This battery is additionally provided with one or multiple safety valves, each of which includes a valve member that is entirely made of thermoplastic resin and will be softened or melted by the heat generated by short-circuit, opening the safety valve.

### SUMMARY

### Technical Problems

Meanwhile, in some batteries, the internal pressure of a case may remain higher than the ambient pressure (i.e., atmospheric pressure) due to the generation of gas during use. However, in the foregoing safety valve including the valve member made of thermoplastic resin, if the internal pressure of the case remains high for a long period, the resin valve member may be deformed due to creep or undergo creep rupture. In addition, when the valve member is made of a resin material, unlike a metal plate, gas or water vapor may permeate the resin material.

The present disclosure has been made to address the above problems and findings has a purpose to provide a power storage device with a safety valve part that opens by softening or melting the resin material that forms the valve member by heat (herein, also referred to as a temperature opening type), but prevents or reduces creep deformation and permeation of gas or water vapor.

### Means of Solving the Problems

(1) To achieve the above-mentioned purpose, one aspect of the present disclosure provides a power storage device comprising a case that is made of metal and includes a safety valve part, wherein the safety valve part is a first safety valve part including: a hole surrounding edge portion defining a valve hole extending through the case; and a valve member hermetically sealing the valve hole, the valve member including: a metal seal plate; and a resin valve member made of thermoplastic resin and formed in a ring shape hermetically sealing a space between a plate circumferential edge portion of the metal seal plate and the hole surrounding edge portion of the case, and the first safety valve part being configured to open when the resin valve member is softened or melted by heat.

This power storage device includes the first safety valve part of a temperature opening type, which is housed in the case. In this power storage device, therefore, when the internal pressure of the case rises and the temperature of the power storage device abnormally increases due to an internal short circuit or a nail penetration test, etc., a part of the ring-shaped resin valve member is softened or melted and thus the first safety valve part opens, releasing high-temperature gas out of the case to reduce the internal pressure and suppress the temperature of the power storage device from increasing.

Moreover, this first safety valve part is not configured to seal the valve hole by joining a valve member made of resin to the hole surrounding edge portion that defines the valve hole. As the valve member for sealing the valve hole, the metal seal plate and the ring-shaped resin valve member surrounding this metal seal plate are used, and the valve hole is hermetically sealed with this ring-shaped resin valve member that hermetically seals a space or gap between the plate circumferential edge portion of the metal seal plate and the hole surrounding edge portion of the case. Accordingly, in the valve member that seals the valve hole, the metal seal plate can bear some of the pressure applied to the valve member, preventing or reducing the possibility of creep in the resin valve member. Further, the amount of resin forming the resin valve member used as the valve member can be reduced and hence the amount of gas or water vapor, which permeates the resin valve member, can be reduced.

Examples of the power storage device include secondary batteries, such as a lithium-ion secondary battery and a sodium-ion secondary battery, and capacitors, such as a lithium-ion capacitor. Further, the power storage device may be a prismatic power storage device with a rectangular parallelepiped case or a cylindrical power storage device with a cylindrical case.

For hermetical joining to the resin valve member, the surface of the plate circumferential edge portion of the metal seal plate and the surface of the hole surrounding edge portion of the case that defines the valve hole may be each subjected to a roughening treatment on a ring-shaped area extending over their entire circumference. The roughening method may include roughening with sandpaper, anodizing, sandblasting, laser roughening, etc.

The thermoplastic resin that forms the resin valve member may be selected in consideration of softening point, melting point, strength, gas permeability, water vapor permeability, and other factors. For example, the thermoplastic resin may be a resin with a melting point in a range of 100° C. to 200° C. Concrete examples of the thermoplastic resin may include PPS, PP, PE, PET, PVDC (polyvinylidene chloride), PVDF (polyvinylidene fluoride), for example.

The metal seal plate is formed in a flat plate-like shape, but may also be formed in a convex protruding shape toward the outside of the case or a concave shape protruding toward the inside of the case. As another example, the metal seal plate may have a spherical (dome-shaped) overall shape or include a ring plate-like shaped plate circumferential edge portion and an inside portion protruding outward or inward in the thickness direction in the form of a dome or a silk hat. The size of the metal seal plate in plan view may be smaller or larger than, or equal to, the size of the valve hole provided in the case. When the metal seal plate is smaller in size than the valve hole, the plate circumferential edge portion of the metal seal plate may be placed inside the valve hole or may be placed more outside or inside than the hole surrounding edge portion of the case in the plate thickness direction. When the metal seal plate is equal to or larger than the valve hole, the plate circumferential edge portion of the metal seal plate is placed more outside than the hole surrounding edge portion of the case in the plate thickness direction.

(2) The power storage device described in (1) may be configured such that the metal seal plate is larger than the valve hole, and the metal seal plate is placed outside of the hole surrounding edge portion in a plate thickness direction with the plate circumferential edge portion covering the hole surrounding edge portion over an entire circumference via the resin valve member.

In the first safety valve part of the above-described power storage device, the metal seal plate larger than the valve hole is used. This metal seal plate is located more outside than the hole surrounding edge portion in the plate thickness direction and further placed so that the plate circumferential edge portion of the metal seal plate covers the hole surrounding edge portion over its entire circumference via the resin valve member. As described above, in the power storage device, the internal pressure of the case may remain higher than the ambient pressure (i.e., atmospheric pressure) due to the generation of gas during use of the power storage device. However, even in such a case, in the first safety valve part of the power storage device, the ring-shaped middle portion of the resin valve member, located between the plate circumferential edge portion of the metal seal plate and the hole surrounding edge portion, is less subjected to stress such as shear stress. This is because the hole surrounding edge portion is present on the inside of the ring-shaped middle portion in the plate thickness direction. The middle portion of the resin valve member can thus be prevented from decreasing in strength due to creep or cracking, making it possible to continuously maintain the hermeticity between the plate circumferential edge portion of the metal seal plate and the hole surrounding edge portion.

(3) The power storage device described in (1) or (2) may be configured such that the hole surrounding edge portion includes a hole-surrounding-edge roughened portion extending in a ring shape in a hole circumferential direction of the valve hole and including first nanocolumns having a height of 50 nm or more that stand in numerous columnar form over an entire circumference, the first nanocolumns being formed of first particles derived from the hole surrounding edge portion of the case and joined together like strings of beads, and the resin valve member includes a hole-surrounding-edge bonding portion made of the thermoplastic resin that forms the resin valve member, the thermoplastic resin being filled in between the first nanocolumns standing numerously, and hermetically bonded to the hole-surrounding-edge roughened portion over the entire circumference.

In this power storage device, the resin valve member can be firmly and hermetically fixed to the hole surrounding edge portion of the case.

(4) The power storage device described in any one of (1) to (3) may be configured such that the plate circumferential edge portion of the metal seal plate includes a plate-circumferential-edge roughened portion extending in a ring shape in a plate circumferential direction of the metal seal plate and including second nanocolumns having a height of 50 nm or more that stand in numerous columnar form over an entire circumference, the second nanocolumns being formed of second particles derived from the plate circumferential edge portion of the metal seal plate and joined together like strings of beads, and the resin valve member includes a plate-circumferential-edge bonding portion made of the thermoplastic resin that forms the resin valve member, the thermoplastic resin filling in between the second nanocolumns standing numerously, and hermetically bonded to the plate-circumferential-edge roughened portion over the entire circumference.

In this power storage device, the resin valve member can be firmly and hermetically fixed to the plate circumferential edge portion of the metal seal plate.

(5) In the power storage device described in any one of (1) to (4), the case may further include a second safety valve part, in addition to the first safety valve part, the second safety valve part being configured to open at a second operating pressure lower than a first operating pressure of the first safety valve part to be opened by an internal pressure of the case.

In addition to the first safety valve part of a temperature opening type that opens at the first operating pressure, the above-described power storage device further includes the second safety valve part of a pressure opening type that opens at the second operating pressure lower than the first operating pressure. Accordingly, if the internal pressure rises due to an internal short circuit or a nail penetration test, etc., the second safety valve part can be opened, separately from the temperature opening type first safety valve part.

### BRIEF DESCRIPTION OF THE DRAWINGS

FIG. 1 is a vertical cross-sectional view of a battery in an embodiment, taken along a line A-A in FIG. 2;

FIG. 2 is a top view of the battery in the embodiment;

FIG. 3 is a partial enlarged cross-sectional view of the battery in the embodiment, showing a cross-section structure of a first safety valve part;

FIG. 4 is an explanatory diagram showing conditions of a hole-surrounding-edge roughened portion and a plate-circumferential-edge roughened portion in the battery in the embodiment;

FIG. 5 is a partial enlarged cross-sectional view of a battery in a modified example 1, showing a cross-section structure of a first safety valve part;

FIG. 6 is a partial enlarged cross-sectional view of a battery in a modified example 2, showing a cross-section structure of a first safety valve part; and

FIG. 7 is a partial enlarged cross-sectional view of a battery in a modified example 3, showing a cross-section structure of a first safety valve part.

### DETAILED DESCRIPTION OF THE EXEMPLARY EMBODIMENTS

### Embodiment

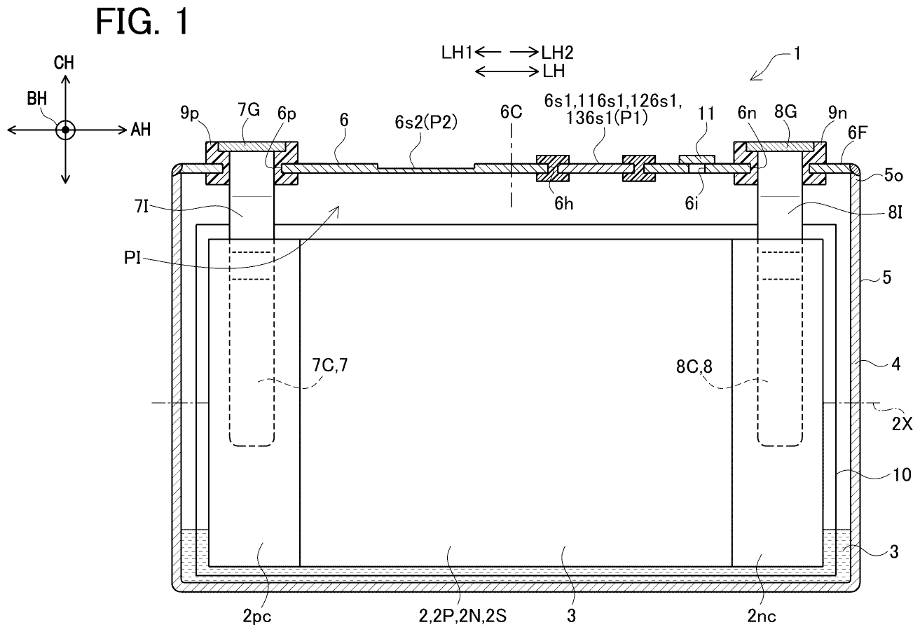

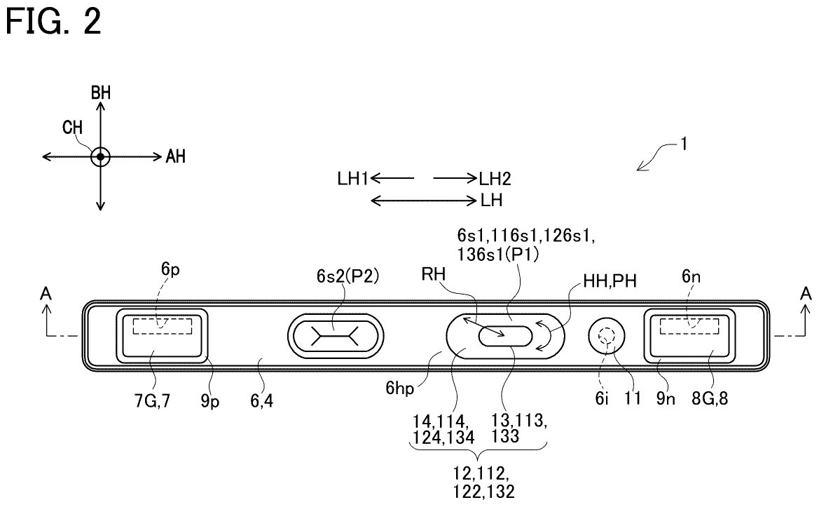

A detailed description of a battery 1 (one example of a power storage device of the disclosure), which is a lithium ion secondary battery, will now be given referring to FIGS. 1 to 4. This battery 1 is a prismatic sealed lithium ion secondary battery, which will be mounted in vehicles, such as a hybrid car, a plug-in hybrid car, an electric car (BEV), or various devices, such as a drone. In the following description, the width direction AH, thickness direction BH, height direction CH of the battery 1 are defined as indicated by arrows in FIGS. 1 and 2.

The battery 1 in the embodiment includes a rectangular case 4, which is thin in the thickness direction BH, an electrode body 2 housed in the case 4 hermetically sealed, and an electrolyte 3 contained in the case 4 and partially impregnated in the electrode body 2. The case 4 is made of metal (aluminum in the embodiment) and formed in a rectangular parallelepiped box-like shape. This case 4 includes a bottomed rectangular tube-shaped case body 5 with a rectangular opening portion 50 and a lid 6 welded to the opening portion 50 to close this opening portion 50. The electrode body 2 is wrapped with a rectangular pouch-shaped insulation film 10 within the case 4. In the case 4, the electrolyte 3 is contained, a part of which is impregnated into the electrode body 2 and the remainder of which accumulates on the bottom of the case 4.

The electrode body 2 housed in the case 4 is a well-known, so-called flat wound electrode body formed of a strip-shaped positive electrode plate 2P and a strip-shaped negative electrode plate 2N, which are wound by interposing a pair of strip-shaped separators 2S, and are depressed into a flat shape in the thickness direction BH perpendicular to the drawing sheet of FIG. 1. This electrode body 2 is oriented sideways in the case 4 so that its winding axis 2X extends in the width direction AH.

In the electrode body 2, the strip-shaped positive electrode plate 2P consists of a positive current collector foil made of an aluminum foil and a positive active material layer overlaid on each side of the foil. The positive active material layers are made of positive active material particles, conductive particles, and a binder. In the embodiment, the positive active material particles are lithium transition metal composite oxide particles, such as lithium nickel cobalt manganese composite oxide particles, for example. An end portion of the strip-shaped positive electrode plate 2P on one side in the width direction (i.e., a left side in FIG. 1) is a positive current collector part 2pc formed of an exposed portion of the positive current collector foil, which is rolled overlapping in a spiral shape.

On the other hand, in the electrode body 2, the strip-shaped negative electrode plate 2N consists of a negative current collector foil made of a copper foil and a negative active material layer overlaid on each side of the foil. The negative active material layers are made of negative active material particles and a binder. In this embodiment, the negative active material particles are graphite particles. An end portion of the strip-shaped negative electrode plate 2N on the other side in the width direction (i.e., a right side in FIG. 1) is a negative current collector part 2nc formed of an exposed portion of the negative current collector foil, which is rolled overlapping in a spiral shape.

The electrolyte 3 is a non-aqueous electrolyte that includes an organic solvent, and a fluorine-containing lithium salt as a supporting salt. In the embodiment, the organic solvent is an organic solvent mixture of ethylene carbonate, ethyl methyl carbonate, and dimethyl carbonate. The fluorine-containing lithium salt in this embodiment is LiPF₆. Further, the salt concentration of the lithium salt in the electrolyte 3 at the time of pouring is 1.1 M.

The lid 6 of the case 4 has a rectangular thin plate-like shape extending in the longitudinal direction LH, i.e., a lateral direction corresponding to the width direction AH in FIGS. 1 and 2. This lid 6 is formed with a rectangular positive-electrode insert hole 6p on one side LH1 (the left side in FIGS. 1 and 2) in the longitudinal direction LH and a rectangular negative-electrode insert hole 6n on the other side LH2 (the right side in FIGS. 1 and 2) in the longitudinal direction LH. The lid 6 is further provided with a liquid inlet 6i. Specifically, in the embodiment, the liquid inlet 6i is located between the negative-electrode insert hole 6n and a first safety valve 6s1 which will be mentioned below. This liquid inlet 6i is hermetically closed with an inlet stopper 11 after pouring of the electrolyte 3. In the lid 6, the first safety valve part 6s1 is placed on the other side LH2 in the longitudinal direction LH relative to the center 6C, while a second safety valve part 6s2 is placed on one side LH1 relative to the center 6C.

In the positive-electrode insert hole 6p of the lid 6, a positive terminal member 7, which is formed by bending an aluminum plate into a predetermined shape, is inserted. This positive terminal member 7 is fixed to the lid 6 while being insulated from the lid 6 via a terminal insulation member 9p. The positive terminal member 7 includes a positive outer connecting portion 7G having a rectangular flat plate-like shape, surrounded by the terminal insulation member 9p and exposed to the outside, a positive inner connecting portion 7C connected to the positive current collector part 2pc located on one end (a left end in FIG. 1) of the electrode body 2, and a positive middle portion 7I connecting those portions 7G and 7C.

Similarly, in the negative-electrode insert hole 6n of the lid 6, a negative terminal member 8, which is formed by bending a copper plate into a predetermined shape, is inserted. This negative terminal member 8 is fixed to the lid 6 while being insulated from the lid 6 via a terminal insulation member 9n. The negative terminal member 8 includes a negative outer connecting portion 8G having a rectangular flat plate-like shape, surrounded by the terminal insulation member 9n and exposed to the outside, a negative inner connecting portion 8C connected to the negative current collector part 2nc located on the other end (a right end in FIG. 1) of the electrode body 2, and a negative middle portion 8I connecting those portions 8G and 8C. Thus, the electrode body 2 is fixed to and held by the lid 6 via the positive terminal member 7 and the negative terminal member 8.

This battery 1 is produced as below. The rectangular pouch-shaped insulation film 10 is placed over the electrode body 2 fixed to the lid 6 via the positive terminal member 7 and the negative terminal member 8. This electrode body 2 is inserted in the case body 5. Then, the rectangular opening portion 50 of the case body 5 and a circumferential edge portion 6F of the lid 6 are hermetically welded together to close the rectangular opening portion 50, completing the case 4. Further, the electrolyte 3 is poured into the case 4 through the liquid inlet 6i so that part of the electrolyte 3 is impregnated in the electrode body 2, and then the liquid inlet 6i is closed with the inlet stopper 11. Thereafter, the battery 1 is completed after undergoing initial charging, high-temperature aging, testing, and others.

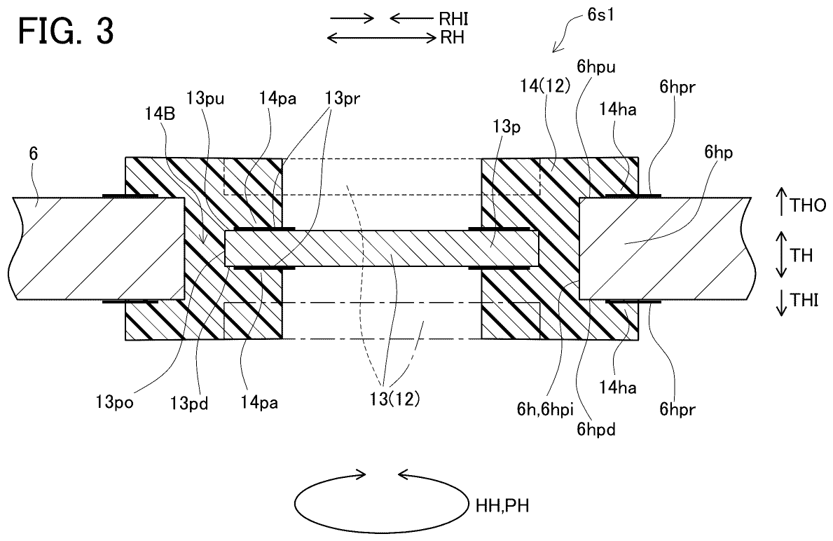

The first safety valve part 6s1 provided in the lid 6 of the case 4 is composed of a hole surrounding edge portion 6hp, which defines an elliptical valve hole 6h penetrating through the lid 6 and extending in the longitudinal direction LH, and surrounds this valve hole 6h, and a valve member 12 hermetically sealing the valve hole 6h, as shown in FIG. 3. The valve member 12 includes a metal seal plate 13 made of aluminum and formed in an elliptical flat plate-like shape similar to but smaller than the valve hole 6h, and a ring-shaped resin valve member 14 that hermetically seals a space between a plate circumferential edge portion 13p of the metal seal plate 13 and the hole surrounding edge portion 6hp of the lid 6. The resin valve member 14 is made of thermoplastic resin, concretely, PPS with a heat resistant temperature of 220° C. The first safety valve part 6s1 is a temperature opening type safety valve part to be opened by softening or melting of the resin valve member 14 caused when the internal pressure PI of the case 4 rises and the temperature of the battery 1 becomes abnormally high. However, even when the resin valve member 14 does not soften or melt, the first safety valve part 6s1 also functions as a non-return, pressure opening type safety valve part to be opened by breakage of the resin valve member 14 when the internal pressure PI of the case 4 greatly rises and exceeds the first operating pressure P1.

On the other hand, the second safety valve part 6s2 is a non-return, pressure opening type safety valve part to be operated at a second operating pressure P2, which is lower (e.g., 30% lower) than the first operating pressure P1 of the first safety valve part 6s1; i.e., P2<P1, P2=0.7P1.

As described above, the battery 1 in the present embodiment includes the temperature opening type first safety valve part 6s1 and additionally the second safety valve part 6s2 that operates at the second operating pressure P2 lower than the first operating pressure P1 of the first safety valve part 6s1. When the battery 1 is short-circuited or subjected to the nail penetration test and the internal pressure of the case 4 rises, the second safety valve part 6s2 can be opened separately from the temperature opening type first safety valve part 6s1.

In addition, the first safety valve part 6s1 in the present embodiment is not configured to seal the valve hole 6h by joining a valve member entirely made of resin to the hole surrounding edge portion that forms the valve hole as in the temperature opening type safety valve described in JP2017-117750A, for example. In the first safety valve part 6s1 in the embodiment, the metal seal plate 13 and the resin valve member 14 surrounding the metal seal plate 13 are used as the valve member 12 for sealingly closing the valve hole 6h, and this valve hole 6h is hermetically sealed with ring-shaped resin valve member 14 that hermetically seals a space between the plate circumferential edge portion 13p of the metal seal plate 13 and the hole surrounding edge portion 6hp of the lid 6. With this configuration, the metal seal plate 13 can bear some of the pressure applied to the valve member 12 that seals the valve hole 6h as the internal pressure PI of the case 4 rises, preventing or reducing the possibility of creep in the resin valve member 14. Further, the amount of resin forming the resin valve member 14 used as the valve member 12 can be reduced, resulting in a reduced amount of gas or water vapor, which permeates the resin valve member 14 to enter into or diffuse out of the case 4.

In the first safety valve part 6s1 in the embodiment, furthermore, an upper surface 6hpu and a lower surface 6hpd of the hole surrounding edge portion 6hp that forms the elliptical valve hole 6h are each provided with a hole-surrounding-edge roughened portion 6hpr with a roughened surface, extending in a ring shape in the hole circumferential direction HH of the valve hole 6h over the entire circumference, as indicated by thick lines in FIG. 3. In the valve member 12 of the first safety valve part 6s1, an upper surface 13pu and a lower surface 13pd of the plate circumferential edge portion 13p of the elliptical metal seal plate 13 are each provided with a plate-circumferential-edge roughened portion 13pr with a roughened surface, extending in a ring shape in the plate circumferential direction PH of the metal seal plate 13 over the entire circumference, as indicated by thick lines in FIG. 13.

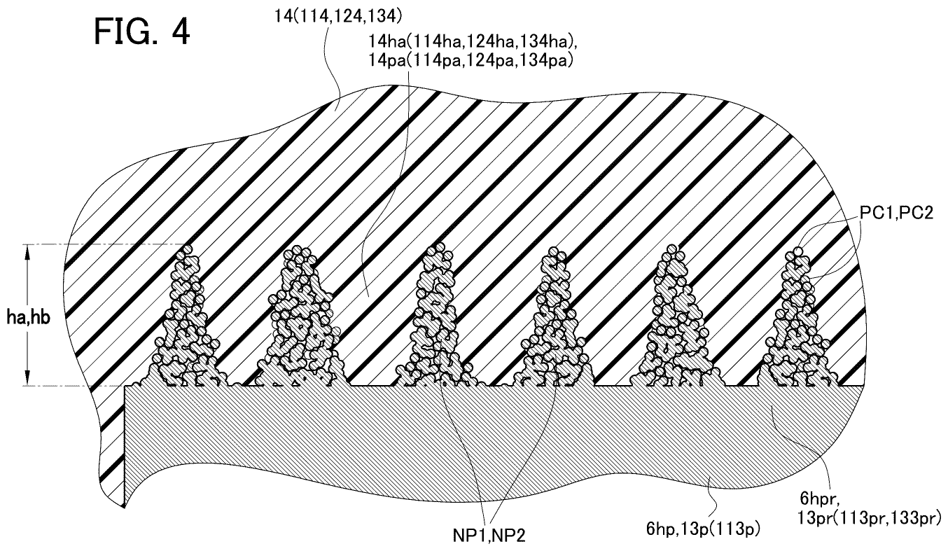

In the first safety valve part 6s1 in the embodiment, further, the hole-surrounding-edge roughened portions 6hpr as part of the hole surrounding edge portion 6hp are subjected to a roughening treatment using a pulse laser beam mentioned later and formed as nano-level nano-roughened portions. To be specific, in the hole-surrounding-edge roughened portions 6hpr, numerous bowl-shaped recesses (not shown) each having a diameter of 30 to 300 μm (in this embodiment, roughly about 80 μm) dented in the shape of bowls are arranged in a grid pattern while partially overlapping one another. On the surface of each bowl-shaped recess that forms the hole-surrounding-edge roughened portion 6hpr, first nanocolumns NP1 having a height of 50 nm or more (in this embodiment, roughly a height ha=200 nm) stand in numerous columnar form over the entire circumference, which are formed of first particles PC1 that are derived from the hole surrounding edge portion 6hp of the lid 6 and joined together like strings of beads as shown in FIG. 4. Since the lid 6 is made of aluminum as described above, the first nanocolumns NP1 are formed of the first particles PC1 made of aluminum and aluminum oxide.

Similarly, the plate-circumferential-edge roughened portions 13pr of the metal seal plate 13 are formed as nano-roughened portions by the roughening treatment using a pulse laser beam. Specifically, in the plate-circumferential-edge roughened portions 13pr, numerous bowl-shaped recesses (not shown) each having a diameter of 30 to 300 μm (in this embodiment, roughly about 80 μm) dented in the shape of bowls are arranged in a grid pattern while partially overlapping one another. On the surface of each bowl-shaped recess that forms the plate-circumferential-edge roughened portion 13pr, second nanocolumns NP2 having a height of 50 nm or more (in this embodiment, roughly a height ha=200 nm) stand in numerous columnar shape over the entire circumference, which are formed of second particles PC2 that are derived from the plate circumferential edge portion 13p of the metal seal plate 13 and joined together like strings of beads as shown in FIG. 4. Since the metal seal plate 13 is also made of aluminum as described above, the second nanocolumns NP2 are formed of the second particles PC2 made of aluminum and aluminum oxide.

Hole-surrounding-edge bonding portions 14ha of the resin valve member 14 are hermetically bonded, or joined, to the ring-shaped hole-surrounding-edge roughened portions 6hpr extending in the hole circumferential direction HH, as part of the hole surrounding edge portion 6hp of the lid 6. Specifically, as shown in FIG. 4, the resin valve member 14 includes the hole-surrounding-edge bonding portions 14ha formed in such a way that the thermoplastic resin that forms the resin valve member 14 is filled in gaps between the first nanocolumns NP1 standing numerously in each hole-surrounding-edge roughened portions 6hpr, and is hermetically bonded to these roughened portions 6hpr over the entire circumference.

Plate-circumferential-edge bonding portions 14pa of the resin valve member 14 are hermetically bonded, or joined, to the plate-circumferential-edge roughened portions 13pr in a ring shape extending in the plate circumferential direction PH, as part of the plate circumferential edge portion 13p of the metal seal plate 13. Specifically, as shown in FIG. 4, the resin valve member 14 includes the plate-circumferential-edge bonding portions 14pa formed in such a way that the thermoplastic resin that forms the resin valve member 14 is filled in gaps between the second nanocolumns NP2 standing numerously in the plate-circumferential-edge roughened portions 13pr, and is hermetically bonded to these roughened portions 13pr over the entire circumference.

In the above way, the resin valve member 14 can be firmly and hermetically fixed to the hole surrounding edge portion 6hp of the lid 6 and also firmly and hermetically fixed to the plate circumferential edge portion 13p of the metal seal plate 13. Thus, the resin valve member 14 can hermetically seal the space between the plate circumferential edge portion 13p of the metal seal plate 13 and the hole surrounding edge portion 6hp of the lid 6 of the case 4. On the other hand, if the internal pressure of the case 4 rises and the temperature of the battery 1 abnormally rises, causing the resin valve member 14 to soften or melt, the resin valve member 14 ruptures, opening the first safety valve part 6s1.

The metal seal plate 13 is made of aluminum as with the lid 6, as described above, but may be made of a different material from the lid 6, such as stainless steel, for example. In the embodiment, the metal seal plate 13 is a flat plate-like member (see FIG. 3), but may be configured as a metal seal plate including a ring plate-like shaped plate circumferential edge portion 13p and an inside portion protruding outward or inward in the thickness direction in the form of a dome or a silk hat. The metal seal plate 13 in this embodiment is a plate material with a smaller thickness than the lid 6, but this thickness of the metal seal plate 13 has only to be selected in consideration of its strength. Therefore, a plate with a thickness equal or nearly equal to the thickness of the lid 6 may be used as the metal seal plate 13.

In the first safety valve part 6s1 in the present embodiment, the metal seal plate 13 is located in the valve hole 6h, i.e., on the inside RHI in the hole diameter direction RH of the valve hole 6h and between the upper surface 6hpu and the lower surface 6hpd of the hole surrounding edge portion 6hp forming the valve hole 6h in the plate thickness direction TH of the lid 6. However, as shown by broken lines in FIG. 3, the metal seal plate 13 may be placed on the inside RHI in the hole diameter direction RH of the valve hole 6h and further on the outside THO (an upper side in FIG. 3) in the plate thickness direction TH relative to the upper surface 6hpu of the hole surrounding edge portion 6hp. Alternatively, as shown in dashed-dotted lines in FIG. 3, the metal seal plate 13 may be placed on the inside RHI in the hole diameter direction RH of the valve hole 6h and further on the inside THI (a lower side in FIG. 3) relative to the lower surface 6hpd of the hole surrounding edge portion 6hp.

For forming the first safety valve part 6s1 in the lid 6, the lid 6 with the valve hole 6h pierced therein is produced by press forming in advance. Further, the hole-surrounding-edge roughened portions 6hpr are formed on the upper surface 6hpu and the lower surface 6hpd of the hole surrounding edge portion 6hp by a roughening treatment using a pulse laser beam. Specifically, the upper surface 6hpu or the lower surface 6hpd of the hole surrounding edge portion 6hp is irradiated with the pulse laser beam, forming a bowl-shaped recess (not shown) at an irradiation site, and thus the aluminum that forms the hole surrounding edge portion 6hp turns into vapor, which condenses into the first particles PC1 made of aluminum and aluminum oxide, and then the first particles PC accumulate on the bowl-shaped recess. When the pulse laser beam is irradiated intermittently in a grid pattern by shifting the irradiating site, many bowl-shaped recesses are formed in the grid pattern while partially overlapping one another. On the surface of each bowl-shaped recess, as shown in FIG. 4, the first particles PC1 accumulate and join together like strings of beads, forming the hole-surrounding-edge roughened portion 6hpr with numerous first nanocolumns NP1 standing in large numbers. The irradiation conditions of the pulse laser beam are set to, for example, a waveform of 1064 nm, a peak output of 5 kW, a pulse width of 150 ns, a spot diameter of 80 μm, and an irradiation-site shifting pitch of 75 μm, which is slightly smaller than the spot diameter (80 μm).

In parallel with production of the lid 6, the metal seal plate 13 is obtained in advance by press punching. Furthermore, as with the hole surrounding edge portion 6hp of the lid 6, the plate-circumferential-edge roughened portions 13pr are formed on the upper surface 13pu and the lower surface 13pd of the plate circumferential edge portion 13p of the metal seal plate 13 by the roughening treatment using a pulse laser beam. Specifically, the upper surface 13pu or the lower surface 13pd of the plate circumferential edge portion 13p is irradiated with the pulse laser beam, forming a bowl-shaped recess (not shown) at an irradiation site, and the aluminum that forms the plate circumferential edge portion 13p turns into vapor, which condenses into the second particles PC2 made of aluminum and aluminum oxide, and then those second particles PC accumulate on the bowl-shaped recess. When the pulse laser beam is irradiated intermittently in a grid pattern by shifting the irradiating site, many bowl-shaped recesses are formed in the grid pattern while partially overlapping one another. On the surface of each bowl-shaped recess, as shown in FIG. 4, the second particles PC2 accumulate and join together like strings of beads, forming the plate-circumferential-edge roughened portion 13pr with numerous second nanocolumns NP2 standing in large numbers. The irradiation conditions of the pulse laser are the same as those for roughening the hole surrounding edge portion 6hp of the lid 6 described above.

Subsequently, the resin valve member 14 is formed by insert molding of injecting thermoplastic resin into the space between the hole surrounding edge portion 6hp of the lid 6 and the plate circumferential edge portion 13p of the metal seal plate 13. Thus, the thermoplastic resin forming the resin valve member 14 is filled in the gaps between the first nanocolumns NP1 in the hole-surrounding-edge roughened portions 6hpr of the lid 6 to form the hole-surrounding-edge bonding portions 14ha. Further, the thermoplastic resin forming the resin valve member 14 is filled in the gaps between the second nanocolumns NP2 in the plate-circumferential-edge roughened portions 13pr of the metal seal plate 13 to form the plate-circumferential-edge bonding portions 14pa.

On the other hand, the lid 6 is formed by press forming of a plate material, and simultaneously the second safety valve part 6s2 is formed by that press forming. As an alternative, a mounting hole (not shown) for a second safety valve part may be pierced in the lid 6 in advance and a metal safety valve part separately produced may be hermetically fixed in this mounting hole by welding or adhering.

### Modified Example 1

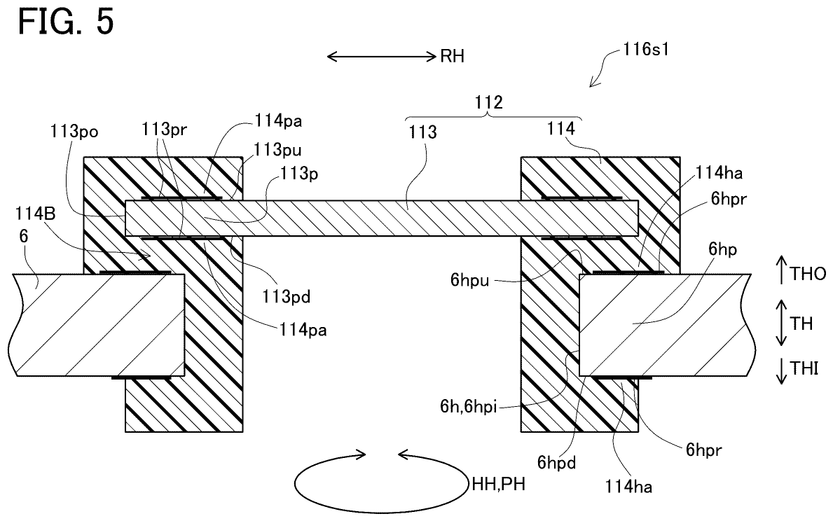

A battery 1 in a modified example 1 (see FIGS. 1, 2, and 5) is a prismatic, sealed lithium ion secondary battery, similar to the battery 1 in the above-described embodiment, but differs in the shape of a first safety valve part 116s1. In the following description, therefore, the same parts as in the embodiment will be omitted or simply mentioned, and the battery 1 in the modified example 1 will be described, focusing on the first safety valve part 116s1 different from that in the embodiment, referring to FIG. 5.

In the first safety valve part 6s1 (see FIG. 3) in the foregoing embodiment, the metal seal plate 13, which is similar in shape to but relatively smaller than the valve hole 6h, is placed within the valve hole 6h. In other words, the metal seal plate 13 is located on the inside RHI of the valve hole 6h in the hole diameter direction RH and between the upper surface 6hpu and the lower surface 6hpd of the hole surrounding edge portion 6hp forming the valve hole 6h in the plate thickness direction TH of the lid 6. In addition, the ring-shaped resin valve member 14 hermetically seals the space between the plate circumferential edge portion 13p of the metal seal plate 13 and the hole surrounding edge portion 6hp of the lid 6, completing the first safety valve part 6s1.

Meanwhile, there is a case in which gas is generated in the case 4 of the battery 1 due to decomposition of the organic solvent that forms the electrolyte 3, and the internal pressure PI of the case 4 remains higher than external atmospheric pressure for a long period. In such a case, in the first safety valve part 6s1 (see FIG. 3), the ring-shaped middle portion 14B of the resin valve member 14 between the hole-surrounding-edge bonding portions 14ha and the plate-circumferential-edge bonding portions 14pa continues to be subjected to shear stress. This may cause concern that the strength of the middle portion 14B is deteriorated due to creep or cracking.

The first safety valve part 116s1 (see FIG. 5) in the present modified example 1 is provided with the elliptical valve hole 6h as in the lid 6, but includes an elliptical metal seal plate 113 similar in shape to but relatively larger than the valve hole 6h, contrary to the metal seal plate 13 in the embodiment. This metal seal plate 113 is placed at a position on the outside THO (an upper side in FIG. 5) of the lid 6 in the plate thickness direction TH relative to the upper surface 6hpu of the hole surrounding edge portion 6hp forming the valve hole 6h to close the valve hole 6h. Specifically, the metal seal plate 13 is located with a plate circumferential edge portion 113p covering the hole surrounding edge portion 6hp of the lid 6 all over the entire circumference. In addition, a ring-shaped resin valve member 114 hermetically seals a space between the plate circumferential edge portion 113p of the metal seal plate 113 and the hole surrounding edge portion 6hp of the lid 6, completing the first safety valve part 116s1.

As mentioned above, in some batteries, the internal pressure PI of the case 4 may remain higher than the atmospheric pressure due to the generation of gas during use. However, even in such a case, in the first safety valve part 116s1, a ring-shaped middle portion 114B of the resin valve member 114, located between the plate circumferential edge portion 113p of the metal seal plate 113 and the hole surrounding edge portion 6hp, is less likely to be subjected to stress, such as shear stress. This is because the hole surrounding edge portion 6hp of the lid 6 is present on the inside THI of the middle portion 114B in the plate thickness direction TH. Thus, the middle portion 114B of the resin valve member 114 can be prevented from decreasing in strength due to creep or cracking, making it possible to continuously maintain the hermeticity between the plate circumferential edge portion 113p of the metal seal plate 113 and the hole surrounding edge portion 6hp of the lid 6.

Also in the first safety valve part 116s1 in the modified example 1, the upper surface 6hpu and the lower surface 6hpd of the hole surrounding edge portion 6hp are each provided with the hole-surrounding-edge roughened portion 6hpr (see FIG. 4) subjected to the roughening treatment with a pulse laser beam, extending in a ring shape in the hole circumferential direction HH over the entire circumference, as shown by thick lines in FIG. 5. Further, as part of a valve member 112 of the first safety valve part 116s1, an upper surface 113pu and a lower surface 113pd of the plate circumferential edge portion 113p of the metal seal plate 113 are each provided with a plate-circumferential-edge roughened portion 113pr (see FIG. 4) subjected to the roughening treatment with a pulse laser beam, extending in a ring shape in the plate circumferential direction PH over the entire circumference, as shown by thick lines in FIG. 5.

In the first safety valve part 116s1 in the modified example 1, accordingly, hole-surrounding-edge bonding portions 114ha of the resin valve member 114 can also be firmly and hermetically fixed to the hole surrounding edge portion 6hp of the lid 6. Further, plate-circumferential-edge bonding portions 114pa of the resin valve member 114 can firmly and hermetically fixed to the plate circumferential edge portion 113p of the metal seal plate 113. Thus, the ring-shaped resin valve member 114 can hermetically seal the space between the plate circumferential edge portion 113p of the metal seal plate 113 and the hole surrounding edge portion 6hp of the lid 6. In contrast, if the internal pressure of the case 4 increases and the temperature of the battery 1 abnormally rises, causing the resin valve member 114 to soften or melt, the resin valve member 114 ruptures, opening the first safety valve part 116s1.

### Modified Example 2

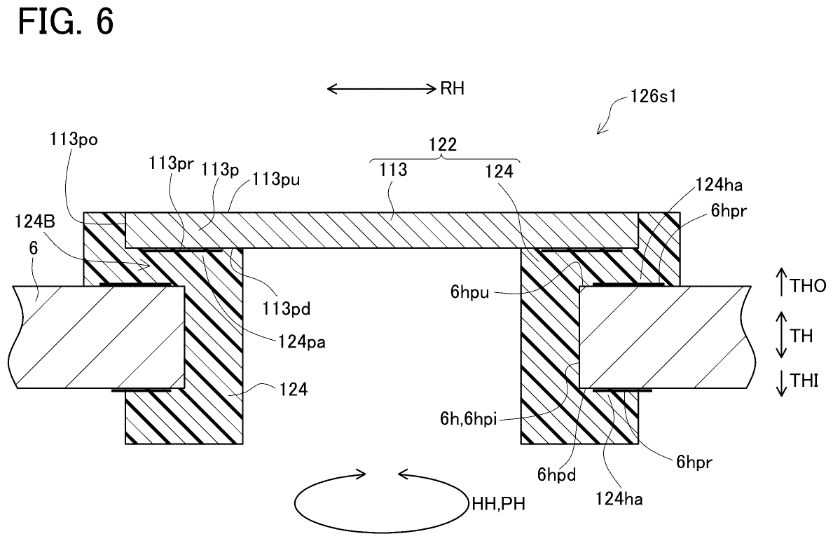

A battery 1 in a modified example 2 (FIGS. 1, 2, and 6) is similar to the battery 1 in the modified example 1, but differs in the shape of a first safety valve part 126s1. Therefore, the first safety valve part 126s1 will be described below referring to FIG. 6.

The first safety valve part 126s1 (see FIG. 6) in the modified example 2 is provided with the valve hole 6h in the lid 6 as in the foregoing embodiment and modified example 1, and additionally, includes an elliptical metal seal plate 113 larger than the valve hole 6h as in the modified example 1. In the first safety valve part 126s1 in the modified example 2, the metal seal plate 113 of a valve member 122 is placed at a position on the outside THO (the upper side in FIG. 6) of the lid 6 relative to the upper surface 6hpu of the hole surrounding edge portion 6hp to close the valve hole 6h. Specifically, the metal seal plate 113 is located with the plate circumferential edge portion 113p covering the hole surrounding edge portion 6hp all over the entire circumference. In addition, a ring-shaped resin valve member 124 hermetically seals a space between the plate circumferential edge portion 113p of the metal seal plate 113 and the hole surrounding edge portion 6hp of the lid 6, completing the first safety valve part 126s1. However, unlike the resin valve member 114 in the modified example 1 (see FIG. 5), the resin valve member 124 is not provided on the outside THO relative to the upper surface 113pu of the plate circumferential edge portion 113p of the metal seal plate 113.

In the first safety valve part 126s1 in the modified example 2, as in the modified example 1, even when the internal pressure PI of the case 4 remains high, a ring-shaped middle portion 124B located between the hole surrounding edge portion 6hp of the lid 6 and the plate circumferential edge portion 113p of the metal seal plate 113 is less likely to be subjected to stress, such as shear stress. This is because the hole surrounding edge portion 6hp of the lid 6 is present on the inside THI of the middle portion 124B in the plate thickness direction TH. Thus, this middle portion 124B of the resin valve member 124 can be prevented from decreasing in strength due to creep or cracking, making it possible to continuously maintain the hermeticity between the plate circumferential edge portion 113p of the metal seal plate 113 and the hole surrounding edge portion 6hp of the lid 6.

Also in the first safety valve part 126s1 in the modified example 2, the upper surface 6hpu and the lower surface 6hpd of the hole surrounding edge portion 6hp are each provided with the hole-surrounding-edge roughened portion 6hpr (see FIG. 4) subjected to the roughening treatment with a pulse laser beam, extending in a ring shape in the hole circumferential direction HH over the entire circumference, as shown by thick lines in FIG. 6. In contrast, only the lower surface 113pd of the plate circumferential edge portion 113p of the metal seal plate 113 is provided with the plate-circumferential-edge roughened portion 113pr (see FIG. 4) subjected to the roughening treatment with a pulse laser beam, extending in a ring shape in the plate circumferential direction PH over the entire circumference.

In the first safety valve part 126s1 in the modified example 2, similarly, hole-surrounding-edge bonding portions 124ha of the resin valve member 124 can be firmly and hermetically fixed to the hole surrounding edge portion 6hp of the lid 6. Further, a plate-circumferential-edge bonding portion 124pa of the resin valve member 124 can be firmly and hermetically fixed to the plate circumferential edge portion 113p of the metal seal plate 113. Thus, the ring-shaped resin valve member 124 can hermetically seal the space between the plate circumferential edge portion 113p of the metal seal plate 113 and the hole surrounding edge portion 6hp of the lid 6. In contrast, if the internal pressure of the case 4 increases and the temperature of the battery 1 abnormally rises, causing the resin valve member 124 to soften or melt, the resin valve member 124 ruptures, opening the first safety valve part 126s1.

### Modified Example 3

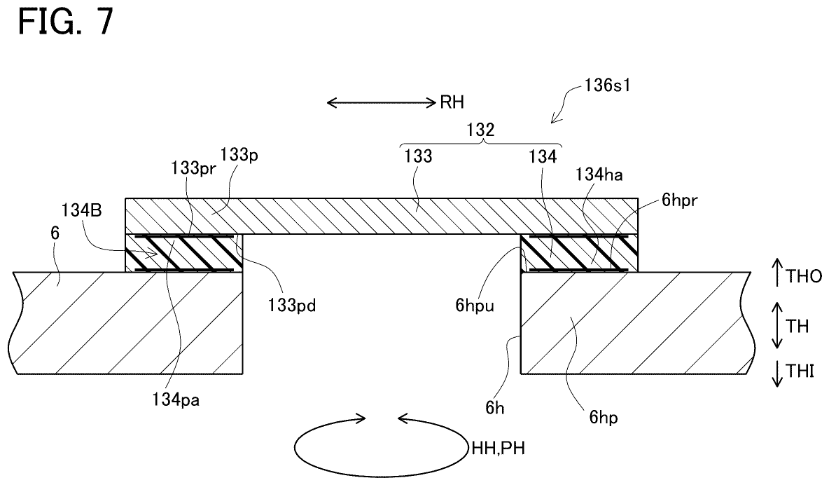

A battery 1 in a modified example 3 (FIGS. 1, 2, and 7) is similar to the batteries 1 in the modified examples 1 and 2, but differs in the shape of a first safety valve part 136s1. Therefore, the first safety valve part 136s1 will be described below referring to FIG. 7.

The first safety valve part 136s1 (see FIG. 7) in the modified example 3 is provided with the valve hole 6h in the lid 6 as in the foregoing embodiment and modified examples 1 and 2, and additionally, includes an elliptical metal seal plate 133 larger than the valve hole 6h and also larger than the metal seal plate 113 in the modified examples 1 and 2. In the first safety valve part 136s1 in the modified example 3, the metal seal plate 133 of a valve member 132 is placed at a position on the outside THO (the upper side in FIG. 7) of the lid 6 relative to the upper surface 6hpu of the hole surrounding edge portion 6hp. Specifically, the metal seal plate 133 is located with a plate circumferential edge portion 133p covering the hole surrounding edge portion 6hp all over the entire circumference. In addition, a ring-shaped resin valve member 134 hermetically seals a space between the plate circumferential edge portion 133p of the metal seal plate 133 and the hole surrounding edge portion 6hp of the lid 6, completing the first safety valve part 126s1. However, unlike the modified examples 1 and 2, the resin valve member 134 in the modified example 3 is provided only between the upper surface 6hpu of the hole surrounding edge portion 6hp of the lid 6 and the lower surface 133pd of the plate circumferential edge portion 133p of the metal seal plate 133.

In the first safety valve part 136s1 in the modified example 3, as in the modified example 1 and 2, even when the internal pressure PI of the case 4 remains high, a ring-shaped middle portion 134B located between the hole surrounding edge portion 6hp of the lid 6 and the plate circumferential edge portion 133p of the metal seal plate 133 is less likely to be subjected to stress, such as shear stress. This is because the hole surrounding edge portion 6hp of the lid 6 is present on the inside THI of the middle portion 134B in the plate thickness direction TH. Thus, the middle portion 134B of the resin valve member 134 can be prevented from decreasing in strength due to creep or cracking, making it possible to continuously maintain the hermeticity between the plate circumferential edge portion 133p of the metal seal plate 133 and the hole surrounding edge portion 6hp of the lid 6.

Also in the first safety valve part 136s1 in the modified example 3, only the upper surface 6hpu of the hole surrounding edge portion 6hp is provided with the hole-surrounding-edge roughened portion 6hpr (see FIG. 4) subjected to the roughening treatment with a pulse laser beam, extending in a ring shape in the hole circumferential direction HH over the entire circumference, as shown by thick lines in FIG. 6. Further, only the lower surface 133pd of the plate circumferential edge portion 133p of the metal seal plate 133 is provided with a plate-circumferential-edge roughened portion 133pr (see FIG. 4) subjected to the roughening treatment with a pulse laser beam, extending in a ring shape in the hole circumferential direction HH over the entire circumference.

In the first safety valve part 136s1 in the modified example 3, similarly, a hole-surrounding-edge bonding portion 134ha of the resin valve member 134 can be firmly and hermetically fixed to the hole surrounding edge portion 6hp of the lid 6. Further, a plate-circumferential-edge bonding portion 134pa of the resin valve member 134 can be firmly and hermetically fixed to the plate circumferential edge portion 133p of the metal seal plate 133. Thus, the ring-shaped resin valve member 134 can hermetically seal the space between the plate circumferential edge portion 133p of the metal seal plate 133 and the hole surrounding edge portion 6hp of the lid 6. In contrast, if the internal pressure of the case 4 increases and the temperature of the battery 1 abnormally rises, causing the resin valve member 134 to soften or melt, the resin valve member 134 ruptures, opening the first safety valve part 136s1.

The disclosure is described in the foregoing embodiment, and modified examples 1 to 3, but is not limited thereto. The present disclosure may be embodied in other specific forms without departing from the essential characteristics thereof. For example, the above-described embodiment and modified examples exemplify the lid 6 formed with the first safety valve part 6s1 having the elliptical valve hole 6h. However, the shape of the valve hole may also be circular or rectangular. As a part of the valve member 12 and others, the elliptical metal seal plate 13 and others, similar in shape to the valve hole 6h, are used. As with this, the metal seal plate 13 may have a circular or rectangular plate-like shape similar to the valve hole according to the shape of the valve hole. In the foregoing embodiment and modified examples, meanwhile, the shape of the metal seal plate is similar to the shape of the valve hole, but may be different from the valve hole.

The foregoing embodiment and modified examples exemplify the hole-surrounding-edge roughened portion 6hpr provided in each of the upper surface 6hpu and the lower surface 6hpd of the hole surrounding edge portion 6hp or in only the upper surface 6hpu, as shown in FIGS. 3, and 5 to 7. In addition, the hole-surrounding-edge roughened portion 6hpr may also be provided in an inner peripheral surface 6hpi of the hole surrounding edge portion 6hp. Further, in the above embodiment and others, the plate-circumferential-edge roughened portion 13pr, 113pr, 133pr is provided in each of the upper surface 13pu, 113p and the lower surface 13pd, 113pd of the plate circumferential edge portion 13p, 113p or in only the lower surface 113pd, 133pd. In addition, it may be also provided in an outer peripheral surface 13po, 113po of the plate circumferential edge portion 13p, 113p.

The embodiment and others exemplify the battery 1 with the flat wound electrode body 2 housed in the case 4. As an alternative, the disclosure may be applied to a battery with a stacked electrode body housed in the case 4, the electrode body including a plurality of positive electrode sheets and a plurality of negative electrode sheets, which are alternately stacked while interposing separator sheets. As another alternative, the disclosure may be applied to a battery with a plurality of electrode bodies, e.g., three flat wound electrode bodies, housed in a case.

In the embodiment and others, furthermore, both the first safety valve part 6s1 and the second safety valve part 6s2 are provided in the same surface of the rectangular parallelepiped case 4, i.e., in the lid 6. As an alternative, a temperature opening type first safety valve part and a pressure opening type second safety valve part may be provided in different surfaces of the case. Further, as long as only the temperature opening type first safety valve part is provided, the pressure opening type second safety valve part does not need to be provided.

### REFERENCE SIGNS LIST

1 Battery (Power storage device)
2 Electrode body
2pc Positive current collector part
2nc Negative current collector part
4 Case
PI Internal pressure (of case)
6 Lid
TH Plate thickness direction
THO Outside (in plate thickness direction)
6s1, 116s1, 126s1, 136s1 First safety valve part
6h Valve hole
HH Hole circumferential direction
6hp Hole surrounding edge portion
6hpu Upper surface (of hole surrounding edge portion)
6hpd Lower surface (of hole surrounding edge portion)
6hpr Hole-surrounding-edge roughened portion
12, 112, 122, 132 Valve member
13, 113, 133 Metal seal plate
PH Plate circumferential direction
13p, 113p, 133p Plate circumferential edge portion
13pr, 113pr, 133pr Plate-circumferential-edge roughened portion
14, 114, 124, 134 Resin valve member
14ha, 114ha, 124ha, 134ha Hole-surrounding-edge bonding portion
14pa, 114pa, 124pa, 134pa Plate-circumferential-edge bonding portion
14B, 114B, 124B, 134B Middle portion
PC1 First particle
PC2 Second particle
NP1 First nanocolumn
NP2 First nanocolumn
ha, hb Height (of nanocolumn)
6s2 Second safety valve part
P1 First operating pressure
P2 Second operating pressure

What is claimed is:

1. A power storage device comprising a case that is made of metal and includes a safety valve part,
wherein the safety valve part is a first safety valve part including:
a hole surrounding edge portion defining a valve hole extending through the case; and
a valve member hermetically sealing the valve hole,
the valve member including:
a metal seal plate; and
a resin valve member made of thermoplastic resin and formed in a ring shape hermetically sealing a space between a plate circumferential edge portion of the metal seal plate and the hole surrounding edge portion of the case, and
the first safety valve part being configured to open when the resin valve member is softened or melted by heat.

2. The power storage device according to claim 1, wherein
the metal seal plate is larger than the valve hole, and
the metal seal plate is placed outside of the hole surrounding edge portion in a plate thickness direction with the plate circumferential edge portion covering the hole surrounding edge portion over an entire circumference via the resin valve member.

3. The power storage device according to claim 1, wherein
the hole surrounding edge portion includes a hole-surrounding-edge roughened portion extending in a ring shape in a hole circumferential direction of the valve hole and including first nanocolumns having a height of 50 nm or more that stand in numerous columnar form over an entire circumference, the first nanocolumns being formed of first particles derived from the hole surrounding edge portion of the case and joined together like strings of beads, and
the resin valve member includes a hole-surrounding-edge bonding portion made of the thermoplastic resin that forms the resin valve member, the thermoplastic resin being filled in between the first nanocolumns standing numerously, and hermetically bonded to the hole-surrounding-edge roughened portion over the entire circumference.

4. The power storage device according to claim 2, wherein
the hole surrounding edge portion includes a hole-surrounding-edge roughened portion extending in a ring shape in a hole circumferential direction of the valve hole and including first nanocolumns having a height of 50 nm or more that stand in numerous columnar form over the entire circumference, the first nanocolumns being formed of first particles derived from the hole surrounding edge portion of the case and joined together like strings of beads, and
the resin valve member includes a hole-surrounding-edge bonding portion made of the thermoplastic resin that forms the resin valve member, the thermoplastic resin being filled in between the first nanocolumns standing numerously, and hermetically bonded to the hole-surrounding-edge roughened portion over the entire circumference.

5. The power storage device according to claim 1, wherein
the plate circumferential edge portion of the metal seal plate includes a plate-circumferential-edge roughened portion extending in a ring shape in a plate circumferential direction of the metal seal plate and including second nanocolumns having a height of 50 nm or more that stand in numerous columnar form over an entire circumference, the second nanocolumns being formed of second particles derived from the plate circumferential edge portion of the metal seal plate and joined together like strings of beads, and
the resin valve member includes a plate-circumferential-edge bonding portion made of the thermoplastic resin that forms the resin valve member, the thermoplastic resin filling in between the second nanocolumns standing numerously, and hermetically bonded to the plate-circumferential-edge roughened portion over the entire circumference.

6. The power storage device according to claim 2, wherein
the plate circumferential edge portion of the metal seal plate includes a plate-circumferential-edge roughened portion extending in a ring shape in a plate circumferential direction of the metal seal plate and including second nanocolumns having a height of 50 nm or more that stand in numerous columnar form over the entire circumference, the second nanocolumns being formed of second particles derived from the plate circumferential edge portion of the metal seal plate and joined together like strings of beads, and
the resin valve member includes a plate-circumferential-edge bonding portion made of the thermoplastic resin that forms the resin valve member, the thermoplastic resin filling in between the second nanocolumns standing numerously, and hermetically bonded to the plate-circumferential-edge roughened portion over the entire circumference.

7. The power storage device according to claim 3, wherein
the plate circumferential edge portion of the metal seal plate includes a plate-circumferential-edge roughened portion extending in a ring shape in a plate circumferential direction of the metal seal plate and including second nanocolumns having a height of 50 nm or more that stand in numerous columnar form over the entire circumference, the second nanocolumns being formed of second particles derived from the plate circumferential edge portion of the metal seal plate and joined together like strings of beads, and
the resin valve member includes a plate-circumferential-edge bonding portion made of the thermoplastic resin that forms the resin valve member, the thermoplastic resin filling in between the second nanocolumns standing numerously, and hermetically bonded to the plate-circumferential-edge roughened portion over the entire circumference.

8. The power storage device according to claim 4, wherein
the plate circumferential edge portion of the metal seal plate includes a plate-circumferential-edge roughened portion extending in a ring shape in a plate circumferential direction of the metal seal plate and including second nanocolumns having a height of 50 nm or more that stand in numerous columnar form over the entire circumference, the second nanocolumns being formed of second particles derived from the plate circumferential edge portion of the metal seal plate and joined together like strings of beads, and
the resin valve member includes a plate-circumferential-edge bonding portion made of the thermoplastic resin that forms the resin valve member, the thermoplastic resin filling in between the second nanocolumns standing numerously, and hermetically bonded to the plate-circumferential-edge roughened portion over the entire circumference.

9. The power storage device according to claim 1, wherein the case further includes a second safety valve part, in addition to the first safety valve part, the second safety valve part being configured to open at a second operating pressure lower than a first operating pressure of the first safety valve part to be opened by an internal pressure of the case.

10. The power storage device according to claim 2, wherein the case further includes a second safety valve part, in addition to the first safety valve part, the second safety valve part being configured to open at a second operating pressure lower than a first operating pressure of the first safety valve part to be opened by an internal pressure of the case.

11. The power storage device according to claim 3, wherein the case further includes a second safety valve part, in addition to the first safety valve part, the second safety valve part being configured to open at a second operating pressure lower than a first operating pressure of the first safety valve part to be opened by an internal pressure of the case.

12. The power storage device according to claim 4, wherein the case further includes a second safety valve part, in addition to the first safety valve part, the second safety valve part being configured to open at a second operating pressure lower than a first operating pressure of the first safety valve part to be opened by an internal pressure of the case.

13. The power storage device according to claim 5, wherein the case further includes a second safety valve part, in addition to the first safety valve part, the second safety valve part being configured to open at a second operating pressure lower than a first operating pressure of the first safety valve part to be opened by an internal pressure of the case.

14. The power storage device according to claim 6, wherein the case further includes a second safety valve part, in addition to the first safety valve part, the second safety valve part being configured to open at a second operating pressure lower than a first operating pressure of the first safety valve part to be opened by an internal pressure of the case.

15. The power storage device according to claim 7, wherein the case further includes a second safety valve part, in addition to the first safety valve part, the second safety valve part being configured to open at a second operating pressure lower than a first operating pressure of the first safety valve part to be opened by an internal pressure of the case.

16. The power storage device according to claim 8, wherein the case further includes a second safety valve part, in addition to the first safety valve part, the second safety valve part being configured to open at a second operating pressure lower than a first operating pressure of the first safety valve part to be opened by an internal pressure of the case.
